(19) United States
(12) Patent Application Publication
(10) Pub. No.: US 2014/0196810 A1
(43) Pub. Date: Jul. 17, 2014

(54) ARMOURING ELEMENT FOR UNBONDED FLEXIBLE PIPE

(71) Applicants: Kristian Glejbol, Glostrup (DK); Nicky Weppenaar, Copenhagen K (DK)

(72) Inventors: Kristian Glejbol, Glostrup (DK); Nicky Weppenaar, Copenhagen K (DK)

(73) Assignee: NATIONAL OILWELL VARCO DENMARK I/S, Brondby (DK)

(21) Appl. No.: 14/238,873

(22) PCT Filed: Aug. 14, 2012
(86) PCT No.: PCT/DK2012/050295

§ 371 Date: Mar. 6, 2014

(30) Foreign Application Priority Data
Aug. 17, 2011 (DK) PA 2011 00621

(51) Int. Cl. F16L 11/08

(52) U.S. Cl. CPC F16L 11/083
USPC 138/137

(57) ABSTRACT

The invention relates to an armouring element for an unbonded flexible pipe. The armouring element has a longitudinal axis and an elongated outer shape along said axis. The armouring element further has a longitudinal recess configured for fully or partly taking up a sensor element. The recess has a recess surface area and at least a surface area fixing part of the recess surface area has a surface finish comprising a surface roughness Ra. The invention further relates to an armouring element assembly and an unbonded flexible pipe comprising the armouring element, and a method of producing an armouring element assembly.

The invention relates to an armouring element for an unbonded flexible pipe. The invention further relates to a method of producing an armouring element assembly for an unbonded flexible pipe.

Unbonded flexible pipes of the present type are well known in the art, in particular for offshore transportation of fluids, e.g. hydrocarbons. For instance unbonded flexible pipes are used for transport of hydrocarbons to or from offshore installations, such as transporting hydrocarbons under sea level. Such pipes usually comprise an inner liner often referred to as an inner sealing sheath or an inner sheath, which forms a barrier against the outflow of the fluid conveyed through the pipe, and one or more armouring layers on the outer side of the inner liner (outer armouring layer(s)). An outer sheath may be provided with the object of providing a mechanical protection and/or for forming a barrier against the ingress of fluids from the pipe surroundings to the armouring layers.

As used in this text the term “unbonded” means that at least two of the layers including the armouring layers and polymer layers are not bonded to each other. In practice the known pipe normally comprises at least two armouring layers located outside the inner sealing sheath. In unbonded pipes, the armouring layers are not bonded to each other or to other layers directly or indirectly via other layers along the pipe. The pipe layers can therefore move relative to each other, and thereby the pipe becomes highly bendable, usable for dynamic applications e.g. as risers, and sufficiently flexible to roll up for transportation even when the layers are relatively thick, which is necessary for high strength pipes which should be able to withstand high pressure differences over layers of the pipe, e.g. pipe differences between the pressure inside the bore of the pipe and the pressure on the outer side of the pipe.

In the standard usually applied for unbonded flexible pipe API specification 17 J “Specification for unbonded flexible pipe”, third edition, published by American Petroleum Institute, and API specification 17 B “Recommended Practice for Flexible Pipe” fourth edition published by American Petroleum Institute additional information on the general state of the art of unbonded flexible pipes can be found.

The layers of the flexible pipe of the invention such as the inner sealing sheath and layers surrounding the inner sealing sheath may be as described above and for example as known from the prior art. Also as described above the flexible pipe may in one embodiment comprise a carcass.

EP1407243 by the applicant discloses a method of mounting a sensor arrangement in a tubular member for use in the monitoring of the tubular member, wherein at least a reinforcement layer is provided on the tubular member by helical winding. The document discloses that the reinforcement layer is formed with a groove which is filled with a liquid material, such as an epoxy type, and wherein the sensor arrangement is passed into the liquid material by means of a pressure applied by a roller prior to the solidification of the liquid material. Furthermore, the document discloses a tubular member comprising a sensor arrangement.

It is an object of the invention to provide an alternative to the above method including to provide an new armouring element, an armouring element assembly, an unbonded flexible pipe, and a method of manufacturing an armouring element assembly that conveniently provides or facilitates a strong and durable bond between the armouring element and a sensor element, while it simultaneously provides a simple production.

This object of the invention is achieved by an armouring element for an unbonded flexible pipe. The armouring element has a longitudinal axis and an elongated outer shape along said axis. The armouring element further has a longitudinal recess configured for fully or partly taking up a sensor element. The recess has a recess surface area and at least a surface area fixing part of the recess surface area has a surface finish comprising a surface roughness Ra value about 0.2 μm or more. Preferably the surface roughness Ra value of the surface area fixing part is about 0.4 μm or more, such as about 0.8 μm or more, such as about 1.6 μm or more, or even about 3.2 μm or more, the surface roughness Ra value of the surface area fixing part being about 100 μm or less, such as about 25 μm or less, or even about 12.5 μm or less. In this way an improved bonding may be achieved between the sensor element and the armouring element, when the sensor element is fastened in the recess with an adhesive.

Accordingly to the invention it has been found that by providing at least a surface area fixing part of the recess surface area with a surface finish comprising a surface roughness Ra value about 0.2 μm or more the bonding between the sensor element and the surface area fixing part has becomes much more stable and durable even when subjected to the chemically aggressive environment which it usually will be when applied for offshore transportation of hydrocarbons, i.e. the armouring element will usually be subjected to aggressive H2S and similar aggressive components.

Such an improved and durable bond between sensor element and surface area fixing part has in particular shown to be an advantage when the armouring element is utilized in hostile environments. In offshore deep waters during extreme pressure and temperature applications, exposed to large physical and/or chemical stresses, prior art armouring elements comprising sensors exhibited increased tendencies to separate between adhesive and recess to such a degree that sometimes the sensors (and adhesive) at least partly loosened from the armouring element. By the invention, it has been realised, that by providing the recess with the claimed roughness, this tendency has been lessened, and the sensor as well as the adhesive stick better to the recess in extreme environments.

The sensor element may in principle be any type of sensor element. Preferably, the sensor element comprises an optical fibre sensor. The recess may be formed by cutting or milling. Optionally, the recess is formed during the manufacture of the armouring element.

By the surface area fixing part of the recess having a roughness with an arithmetic average of the roughness of the recess surface (Ra)-value according to these values, an improved adhesive bond may be achieved between the armouring element and the sensor element at the surface area fixing part. The Ra-value may be measured in accordance with the ISO 4287, DIN 4762 and/or DIN 4768 standards, with a roughness cut-off wavelength, L_{c} of 2.5 mm.

In one embodiment of the invention, the recess is a groove.

In one embodiment of the invention, the surface area fixing part is or comprises substantially the whole recess surface area.

In one embodiment of the invention, the surface area fixing part comprises multiple surface area fixing sections.

In one embodiment of the invention, at least a first surface area fixing section extends over a substantially full recess width and over a section length along the longitudinal direction.

In one embodiment of the invention, the section length is about 10 mm or more, such as about 50 mm or more, or even such as about 100 mm or more, and wherein the section length is about 2000 mm or less, such as about 1000 mm or less, or even such as about 500 mm or less.

In one embodiment of the invention, the surface area fixing part has a mean section spacing between neighbouring surface area fixing sections. The mean section spacing is about 1 mm or more, such as about 10 mm or more, about 50 mm or more, or even about 200 mm or more, the mean section spacing being about 5000 mm or less, such as about 3000 mm or less, about 1000 mm or less, or even about 500 mm or less. The mean section spacing is the arithmetic mean of section spacings between all neighbouring surface area fixing sections. The section spacing between a first and a second surface area fixing section is here defined as the smallest distance between a point in the first surface area fixing section and a point in the second, when measured along the recess.

In one embodiment of the invention, the armouring element comprises at least a first surface area fixing part and a second surface area fixing part.

In one embodiment of the invention, the first and second surface area fixing parts have a part spacing, the part spacing being about 1 m or more, such as about 10 m or more, such as about 50 m or more, such as about 100 m or more, the part spacing being about 10 km or less, such as about 1 km or less, such as about 500 m or less, such as about 200 m or less, when measured along the recess.

In one embodiment of the invention, the groove is U-shaped. The U-shaped groove optionally has a width in the range from about 0.5 mm to about 5 mm, such as from about 1 mm to about 3 mm, or even such as from about 1.5 mm to about 2 mm, and a depth in the range from about 0.5 mm to about 5 mm, such as from about 1 mm to about 3 mm, or even such as from about 1.5 mm to about 2 mm. The groove is then capable of housing most known sensor elements and the U-shape ensures that a minimum of stress is induced into the armouring element due to the groove.

In one embodiment of the invention, the groove is box-shaped in that it has a substantially rectangular cross section. Optionally, the box-shaped groove has a width in the range from about 0.5 mm to about 5 mm, such as from about 1 mm to about 3 mm, or even such as from about 1.5 mm to about 2 mm, and a depth in the range from about 0.5 mm to about 5 mm, such as from about 1 mm to about 3 mm, or even such as from about 1.5 mm to about 2 mm.

In one embodiment of the invention, the element comprises a longitudinally extending outer surface area section wherein the outer surface area section is coarser than the surface area fixing part. Throughout this text, a first surface being coarser than a second surface is defined to indicate that the Ra-value of the first surface is higher than the Ra-value for the second surface. Analogously, a first section being coarser than a second section is defined to indicate that the surface of the first section is coarser than the surface of the second section.

In one embodiment of the invention, the element comprises a longitudinally extending outer surface area section wherein the surface area fixing part is coarser than the outer surface area section.

In one embodiment of the invention, the armouring element further comprises at least a second outer surface area section, wherein the surface area fixing part is coarser than both the outer surface area section and the second outer surface area section.

In one embodiment of the invention, the armouring element further comprises at least a second outer surface area section, wherein the surface area fixing part is coarser than at least one of said outer surface area sections.

In one embodiment of the invention, the armouring element is made of or comprises a metal.

In one embodiment of the invention, the armouring element is made of or comprises a fibre-reinforced polymer.

In one embodiment of the invention, the armouring element comprises a substantially rectangular cross-section.

In one embodiment of the invention, the recess is substantially centred on a surface area section of the substantially rectangular cross-section.

An object of the invention is achieved by an armouring element assembly comprising an armouring element according to any of the abovementioned embodiments and a sensor element, the sensor element being fixed in the recess of the armouring element in contact with an adhesive. In this way, the sensor element is conveniently fixed in the recess. The surface roughness of the surface area fixing part improves the adhesion of the adhesive to the recess surface area. The sensor element may in an embodiment of the armouring element assembly according to the invention be fixed at least in the surface area fixing part in the recess of the armouring element.

In one embodiment of the armouring element assembly according to the invention, the dimensions of the sensor element and the recess have been preselected such that at least said surface area fixing part is in contact with a surface of said sensor element along substantially the entire longitudinal length of the sensor element.

In one embodiment of the armouring element assembly according to the invention, the adhesive is or comprises a polyurethane. In this way a strong adhesion is achieved between the sensor element and the armouring element.

In another embodiment of the armouring element assembly according to the invention, the adhesive is or comprises a polyolefin.

In one embodiment of the armouring element assembly according to the invention, the adhesive is or comprises a thermoplastic. By using a thermoplastic as adhesive, the sensor element or parts thereof may be separated from the armouring element simply by heating the assembly over the desired length sufficiently for the thermoplastic to reach a temperature above the glass transition temperature of the thermoplastic. Then the sensor element may be retrieved from the recess over the heated length. In this way, manufacture of armouring element assemblies for an unbonded flexible pipe may be simplified, as assemblies may be manufacture in long lengths and subsequently be cut into the desired lengths. Thereafter, the sensor element may be separated from a length of the cut armouring element assembly, e.g. for connection of the sensor element in an assembly to a sensing system located away from the unbonded flexible pipe.

In one embodiment of the armouring element assembly according to the invention, the thermoplastic is or comprises one or more of a polyamide, a polyolefin, and/or an acrylic compound. Polyolefin is well suited for use in the harsh environment of the pipe annulus, i.e. a wet, warm and acidic environment. Furthermore, polyolefin may have a strong adhesion to metal surfaces, e.g. a metallic armouring element. Additionally, polyolefin is generally commercially available.

In one embodiment of the armouring element assembly according to the invention, the recess is adapted to fully contain the sensor element. In this way, the sensor element is protected from mechanical influences, such as impact or wear, by being recessed below a surface of the armouring element and optionally being encapsulated by the adhesive.

In one embodiment of the armouring element assembly according to the invention, the sensor element is or comprises an optical fibre sensor. Thereby, a non-conducting sensor may be obtained, thus reducing the risk of igniting the fluid conveyed in the pipe.

In one embodiment of the armouring element assembly according to the invention, the optical fibre sensor comprises a strain sensor. In this way, remote sensing of strain in the armouring element assembly may be performed, e.g. to monitor the structural integrity of the pipe, to monitor for breaks of armouring elements, etc.

In one embodiment of the armouring element assembly according to the invention, the optical fibre sensor comprises a temperature sensor. Thus, monitoring of a temperature of the pipe and/or a fluid conveyed in the pipe is enabled. Such monitoring may allow for optimising production parameters, monitor remaining life time of the pipe, etc.

In one embodiment of the armouring element assembly according to the invention, the optical fibre sensor comprises a pressure sensor.

In one embodiment of the armouring element assembly according to the invention, the optical fibre sensor comprises an acoustic sensor.

A further object of the invention is achieved by an unbonded flexible pipe comprising at least a first armouring element assembly according to any abovementioned embodiments.

In one embodiment of the unbonded flexible pipe according to the invention, the pipe comprises a tensile armouring layer, and the tensile armouring layer comprises the first armouring element assembly.

In one embodiment of the unbonded flexible pipe according to the invention, the tensile armouring layer additionally comprises at least a first armouring element of a second type. The armouring element of the second type does not comprise a sensor element. Thus, the tensile armouring layer may comprise a combination of one or more armouring element assemblies according to the invention, and one or more armouring elements of the second type. Here the armouring element assemblies provide both mechanical strength, such as tensile strength, to the pipe structure and sensing capabilities of the sensor elements. In contrast, the armouring elements of the second type merely provide mechanical strength to the structure. Using a few or maybe only one sensor in such a flexible pipe may be entirely satisfactory to provide the necessary data from the sensor in the pipe.

In one embodiment of the unbonded flexible pipe according to the invention, a mechanical strength, such as a tensile strength, of the first armouring element assembly is substantial equal to the mechanical strength of the first armouring element of the second type. Thus, the first armouring element assembly may be adapted to have substantially equal mechanical properties to the first armouring element of the second type, so as to not change the mechanical properties of the pipe by replacing a number of armouring elements of the second type by armouring element assemblies.

In one embodiment of the unbonded flexible pipe according to the invention, the tensile armouring layer additionally comprises a second armouring element assembly, and optionally a third, a fourth, or a fifth armouring element assembly. In general, any number of armouring elements of the tensile armouring layer may be armouring elements assembly, i.e. up to 100% of the armouring elements of the tensile armouring layer, such as up to about 75%, or even such as up to about 50%.

An object of the invention is also achieved by a method of manufacturing an armouring element assembly for an unbonded flexible pipe. The method comprises forming an elongated armouring element having a length along a longitudinal axis. The method further comprises forming a longitudinal recess in the element along the longitudinal axis thereof, the recess having a recess surface area. The method further comprises providing a surface area fixing part of the recess surface area with a surface finish comprising a surface roughness, the surface roughness Ra-value of the surface area fixing part being about 0.2 μm or more. The method further comprises applying an adhesive to at least the surface area fixing part of the recess surface area, providing a sensor element, and applying the sensor element in the recess in contact with the adhesive. In this way, a convenient method of manufacturing an armouring element assembly is obtained, wherein the need for, e.g. mechanical locking of the sensor element in the recess instead of or in combination with the use of an adhesive may be alleviated. During manufacturing, it is an advantage to provide the recess area fixing part with increased roughness, because the sensor has shown to be easier to insert into the recess. Further it has been found that any need for further steps of mechanical locking in place is not required, even when the elongated armouring element is to be applied in chemically aggressive environment.

In an embodiment the method comprises providing a sensor element, applying an adhesive to a surface of the sensor, and applying the sensor element in the recess such that at least the surface area fixing part is in contact with the adhesive. During manufacturing, it is an advantage to provide the recess area fixing part with increased roughness even where the sensor is provided with adhesive, since it may take a while for the adhesive to cure, depending on type of adhesive used. The increased roughness of the recess area fixing part has shown to make it simpler to avoid that the sensor is slipping out of the recess during manufacturing.

In an embodiment the method comprises providing a sensor element, applying the sensor element in the recess, and applying an adhesive on top of the sensor, such that at least the surface area fixing part and the surface of the sensor are in contact with the adhesive. When positioned in the roughened recess before an adhesive is applied, there is much less risk that the sensor slips out of the recess during or after application of the adhesive. An advantage is then that no specialized adhesive application apparatus is required.

The recess may be produced in a variety of ways, e.g. by machining such as rolling, milling or cutting. The desired roughness may be obtained in various ways, either during the formation of the recess or by post processing of the recess, such as honing. For instance, the recess may be post processed with a textured roll, or by abrasive blasting.

In one embodiment of the method according to the invention, the method further comprises immersing the sensor element into the adhesive by mechanical action of a force applying tool. This ensures a good contact between the recess surface area fixing part and the adhesive, and between the adhesive and the sensor element. Additionally, the tool may be used to firmly seat the sensor element in the recess, so that the sensor element is brought closely in contact with the recess surface area fixing part, preferably only separated by a thin layer of adhesive. In general the force applying tool may take many different forms. Preferably, the force applying tool comprises a glider for applying a force to the sensor element and being adapted to force the sensor element into the recess and thereby to immerse it in the adhesive. Alternatively, the tool comprises a wheel adapted to force the sensor element in the recess.

In one embodiment of the method according to the invention, the force applying tool is a glider.

In one embodiment of the method according to the invention, the adhesive is or comprises a polyurethane and/or a polyolefin.

In one embodiment of the method according to the invention, the adhesive is or comprises a thermoplastic. Advantages of using a thermoplastic as the adhesive are mentioned above.

In one embodiment of the method according to the invention, the thermoplastic is or comprises a polyamide. Advantages of using these materials are stated above.

In one embodiment of the method according to the invention, the method further comprises shot peening at least a part of the recess surface area. In this way, tensile stresses in the recess surface area may be relieved, thereby improving a life time of the armouring element.

In one embodiment of the method according to the invention, the armouring element assembly is manufactured in a continuous length. The method further comprises cutting the armouring element assembly to a desired length, and separating a separated length section of the sensor element from the armouring element by heating the separated length section. In the present context, a continuous length is taken to mean a length significantly longer than the desired length, the latter in general being substantially the length of a single armouring element in an assembled unbonded flexible pipe. Thus, if the pipe comprises multiple armouring elements, the desired length is the length of one of such armouring elements, not the combined length of all or some of the armouring elements. A continuous length in this context may thus e.g. be a length of about 0.1 km or more, about 0.5 km or more, about 1 km or more, about 2 km or more, about 5 km or more, or a length of about 10 km or more, such as a length of about 20 km or more, or even such as about 30 km or more.

In one embodiment of the method according to the invention, the desired length is substantially the length of an armouring element in an assembled unbonded flexible pipe.

In one embodiment of the method according to the invention, the desired length is substantially shorter than the length of an armouring element in an assembled unbonded flexible pipe. This may for instance be the case if monitoring of the pipe by the sensor element is only desired along a subpart of the length of the pipe. Then the armouring element assembly may have a length corresponding to the length of the subpart, when taking into account a longer path length of the assembly due to a generally helical path along the pipe. In many cases, armouring elements must be continuous throughout the whole length of the pipe, in which case, an end of the assembly may be welded or otherwise joined to an end of another armouring element to achieve a combined length corresponding to the length of the pipe.

In one embodiment of the method according to the invention, the separated length of the sensor element is an end section of the sensor element. In this way, the sensor element may conveniently be connected to an external monitoring system, while the armouring element may be fastened in an end-fitting.

In one embodiment of the method according to the invention, the separated length section of the sensor element is an internal length section of the sensor element. In this way, the internal length section, i.e. a section being away from the ends of the sensor element, may be manipulated, e.g. during production. For instance, if the sensor element is an optical fibre sensor, the fibre may be cut at a point along the internal length section to splice, e.g. a point-sensing element into the optical path of the optical fibre sensor.

In one embodiment of the method according to the invention, the armouring element assembly manufactured is an armouring element assembly according to any of the abovementioned embodiments.

The invention will be explained more fully below in connection with preferred embodiments and with reference to the drawings in which:

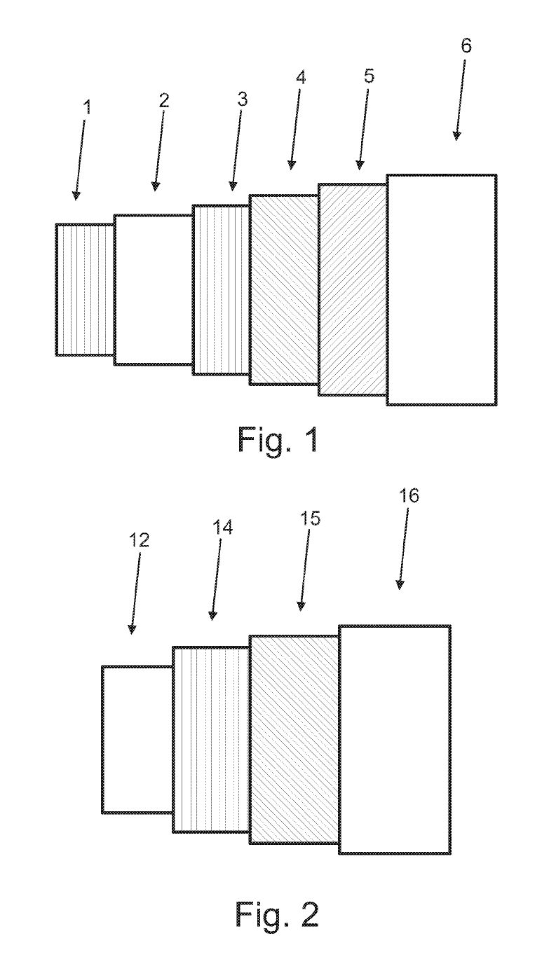

FIG. 1 is a schematic side view of a flexible pipe with a carcass;

FIG. 2 is a schematic side view of a flexible pipe without a carcass;

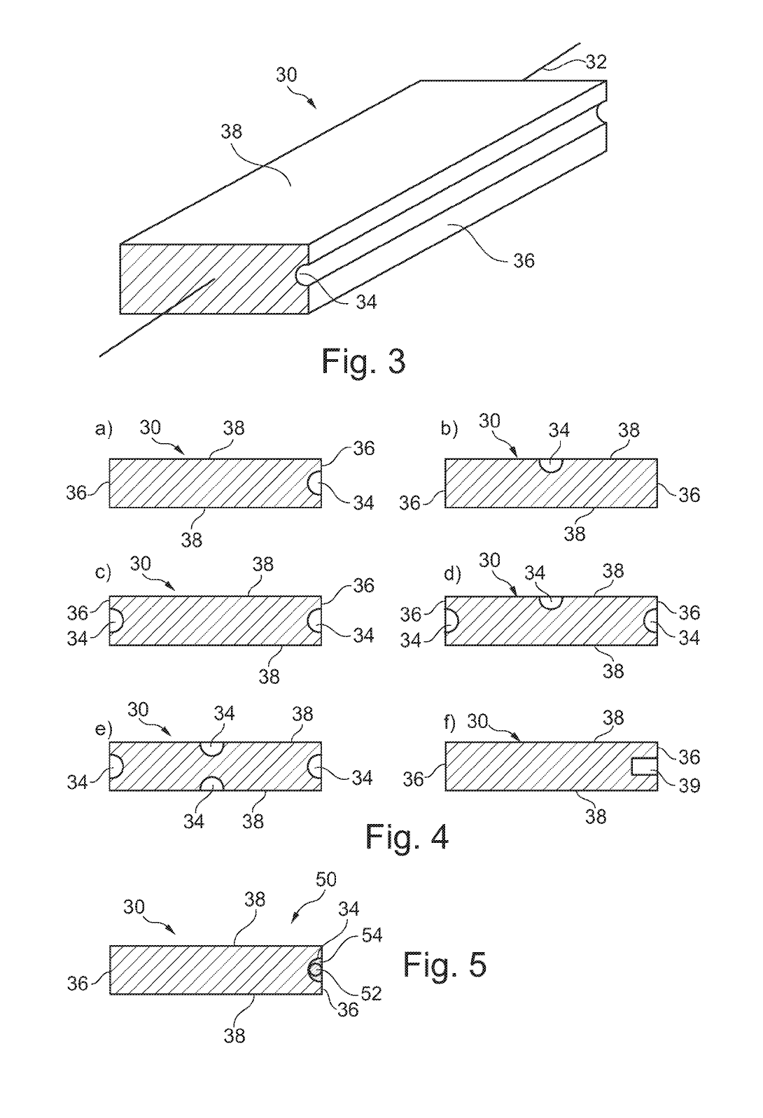

FIG. 3 schematically shows a section of an armouring element according to the invention;

FIG. 4 shows cross-sections of armouring elements according to the invention;

FIG. 5 shows a cross-section of an armouring element assembly according to the invention;

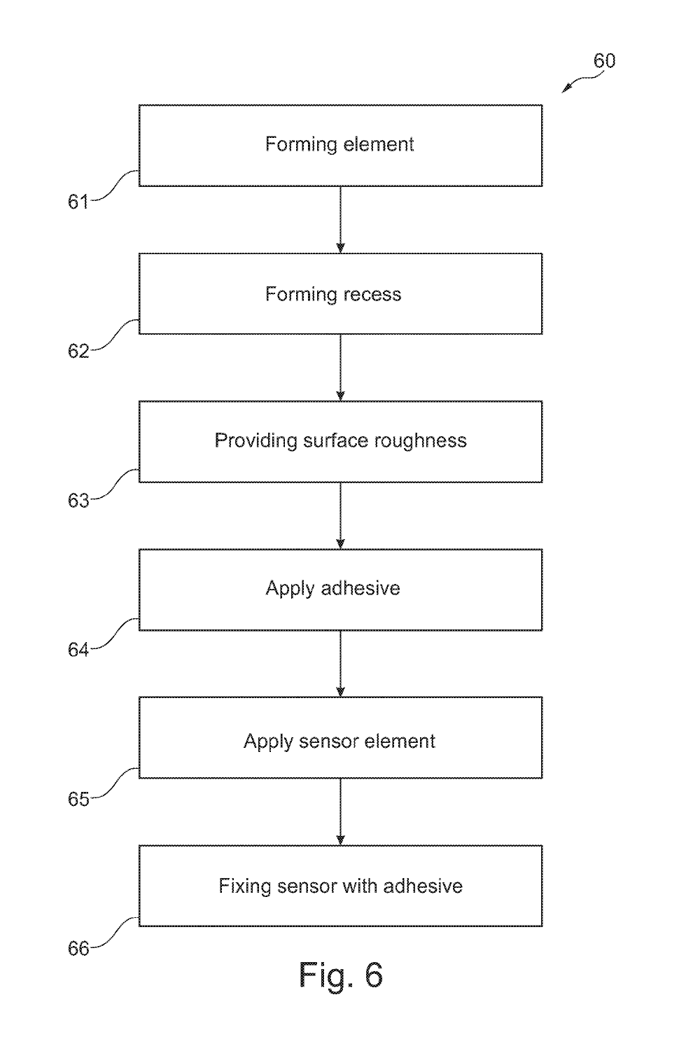

FIG. 6 is a diagram showing the method of manufacturing an armouring element assembly; and

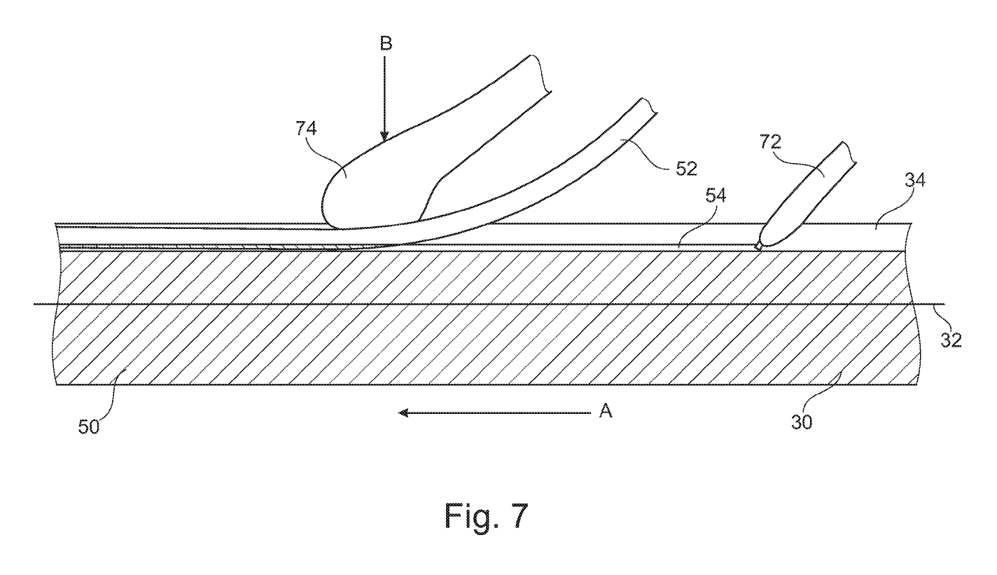

FIG. 7 shows manufacturing of an armouring element assembly by the method according to the invention.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent from this detailed description to those skilled in the art.

The unbonded flexible pipe according to one aspect of the invention may for example have a structure as described in any one of the documents EP 1255944, EP 1269057, EP 1384026, EP 1475650, EP 1277007, EP 1269058, EP 1119684, U.S. Pat. No. 6,123,114, U.S. Pat. No. 6,691,743, U.S. Pat. No. 6,668,867, U.S. Pat. No. 5,813,439, WO 0242674, U.S. Pat. No. 5,730,188, U.S. Pat. No. 6,354,333, U.S. Pat. No. 4,549,581, U.S. Pat. No. 6,192,941, U.S. Pat. No. 6,283,161, WO 0181809, WO 0036324, U.S. Pat. No. 6,454,897, U.S. Pat. No. 6,408,891 and U.S. Pat. No. 6,110,550, WO2009106078, WO 2008113362, EP 1937751, U.S. Pat. No. 6,145,546, U.S. Pat. No. 6,123,114 and U.S. Pat. No. 6,668,866 with the difference that the unbonded flexible pipe comprises an armouring element assembly as described herein.

The flexible pipe shown in FIG. 1 comprises a tubular inner sealing sheath 2, often also called an inner liner, e.g. of cross linked poly ethylene (PEX). Inside the inner sealing sheath 2 the pipe comprises an internal armouring layer 1, called a carcass. On the outer side of the inner sealing sheath 2, the flexible pipe comprises three outer armouring layers 3, 4, 5. The outer armouring layer 3 closest to the inner sealing sheath 2 is a pressure armouring layer 3, made from profiles and/or strips wound with a short pitch and thereby at a steep angle to the centre axis of the pipe, e.g. close to 90 degrees. Around the pressure armouring layer 3, the pipe comprises a pair of cross wound tensile armouring layers 4, 5, made from wound profiles and/or strips. The tensile armouring layers 4, 5 are normally cross wound with equal or different angles of 70 degrees or less, typically 60 degrees or less, such as 55 degrees or less, such as between 20 and 55 degrees. The pipe further comprises an outer polymer layer (outer protective layer) 6 protecting the armouring layer mechanically and/or against ingress of sea water. The materials used are well known in the art.

Between the inner sealing sheath 2 and the outer sheath is provided an annulus, also called an annulus cavity. In this annulus cavity the pressure armouring layer 3 and the tensile armouring layers 4, 5 are placed. The armouring layers are not fluid tight.

The flexible pipe is a harvesting pipe for transporting oil, gas or similar fluids from a well to a collecting unit such as a sea surface installation (usually a ship or a platform). A bore defined by the inner sealing sheath 2 (i.e. the area surrounded by the inner side of the inner sealing sheath) provides a transportation path. The internal armouring layer 1 is placed in the bore.

FIG. 2 shows another pipe design. This flexible pipe comprises a tubular inner sealing sheath 12 and a pair of outer armouring layers, 14, 15, in the form of profiles and/or strips wound around the inner sealing sheath 12. The two armouring layers are cross wound at an angle to the centre axis of the pipe of close to 55 degrees, typically one of the layers is wound at an angle slightly less than 55 degrees, e.g. between 52 and 55 degrees, and the other one of them is wound at an angle slightly more than 55 degrees e.g. between 55 and 57. The pipe further comprises an outer protective layer 16 protecting the armouring layer mechanically and/or against ingress of sea water.

Between the inner sealing sheath 12 and the outer sheath 16 is provided an annulus, also called an annulus cavity. In this annulus cavity the outer armouring layers 14, 15 are placed. The armouring layers are not fluid tight.

Also this pipe may be a harvesting pipe as described above and comprises a bore defined by the inner sealing sheath 12, which provides a transportation path.

FIG. 3 shows a section of an armouring element 30 according to the invention. Typically, the armouring element 30 is made from metal, such as steel, aluminium or titanium. Alternatively, the element 30 may be made from fibre reinforced polymers, such as polyester, vinylester, or epoxy reinforced with e.g. glass- or carbon fibres. The armouring element 30 has a longitudinal axis 32, along which it extends. Here, only a short section of the element is shown, while in practice the element may be made in very long lengths, e.g. several kilometres or even tens of kilometres. The armouring element 30 has a recess 34, here in the form of a U-shaped groove, which is adapted for taking up a sensor element to make an armouring element assembly. The recess may be adapted for fully or partly taking up the sensor element. In a preferred embodiment, the sensor element may be fully embedded in the recess 34. The recess 34 having a recess surface area is orientated in the longitudinal direction of the element and may run for the whole length of the element. Alternatively, the recess 34 may be provided along only a part of the length of the element. The armouring element 30 may be made in many different cross-sectional shapes, not being limited to the substantially rectangular cross-section shown here. For instance, the armouring element may be a profiled wire or may be a rolled strip with rounded edges.

To facilitate the fixing of a sensor element in the recess 34 by an adhesive, a surface area fixing part of the recess surface area is provided with a coarse surface finish to improve adhesion of the adhesive to the recess surface, both during manufacturing of the armouring element assembly, but also when the armouring element is put into operation. The surface area fixing part may e.g. be coarse by having a roughness with an arithmetic mean deviation Ra of about 0.2 μm or more. The roughness may be measured in accordance with DIN 4762, DIN 4768, or ISO 4287. The skilled person will realise that the desired surface finish may be achieved in many ways, either during production of the recess 34, or in a post-production step. For instance, a recess with the desired surface finish may be achieved by electro-chemical methods, etching, abrasive blasting (sandblasting, glass blasting, etc.), or machining, such as rolling, milling, cutting or honing.

For example, a recess 34 made by cutting may have a roughness Ra-value of about 0.8 μm or larger, such as about 1.6 μm or larger, or even such as about 3.2 μm or larger, the value being about 50 μm or smaller, such as about 25 μm or smaller, or even about 12.5 μm or smaller.

FIG. 4a-4f illustrate cross-sections of various configurations armouring element 30, wherein one or more recesses 34 are located in either a narrow surface area section 36, a wide surface area section 38, or in both. Here, the recesses 34 are illustrated as being centred on the respective surface area sections; this however need not be the case. FIG. 4a-4e illustrate recesses 34 having U-shaped cross-sections, while FIG. 4f illustrates a recess 39 with a box-shaped cross-section in a configuration similar to that of FIG. 4a. The skilled person will realise that box-shaped recesses may also be used in the configurations of FIG. 4b-4e without deviating from the scope of the invention.

FIG. 5 shows a cross-section of an armouring element assembly 50, comprising an armouring element 30 as the one shown in FIG. 4a and a sensor element 52. The sensor element 52 has been mounted in the recess 34 in contact with an adhesive 54. The sensor element 52 is seen to be fully contained in the recess 34, i.e. being recessed below a surface level of the surface 36 in which the recess 34 was formed.

In this way, the sensor element 52 is protected from damage during production and use of the flexible pipe. However, in other embodiments, the sensor element 52 may be only partly contained in the recess, i.e. so as to partly protrude above the surface level of the surface 36 in which the recess 34 was formed. In general, many different types of adhesives may be used, provided that they are able to withstand the environment within annulus of the flexible pipe and that they provide a sufficiently strong bond between the sensor element 52 and the armouring element 30.

### EXAMPLE 1

In an example, the armouring element is made from steel with a substantially rectangular cross-section having a width of a wide side of approximately 20 mm and a height of a narrow side of 5 mm. A recess is formed approximately centred on the narrow side and is provided as a U-shaped groove with a depth of approximately 1.5 mm and a width of approximately 1 mm. The surface area fixing part in this example comprises substantially the whole recess surface area. Prior to mounting the sensor element, the armouring element is degreased and grit blasted in the groove to obtain the required roughness and thus to form the surface area fixing part. An exception is that areas of the groove towards the ends of the armouring element are preferably not grit blasted, so that the sensor element may conveniently be retrieved from the groove in these areas for connection of the sensor element to an external sensing system. A sensor element in the form of an optical fibre sensor being substantially circular in cross-section and having a diameter of approximately 0.8 mm is fixed in the recess by a thermoplastic adhesive in the form of polyamide. The optical fibre sensor may be any of a wide range of fibre optical sensors, but may in one example comprise a number of fibre Bragg gratings arranged to allow quasi-distributed strain sensing in the armouring element.

FIG. 6 schematically illustrates an embodiment of the method 60 of manufacturing an armouring element assembly. As a first step, an armouring element is formed 61 by conventional methods, e.g. by rolling or cogging. The armouring element may be manufactured in a number of sections, which are subsequently joined, e.g. by welding. The recess having a recess surface area is formed 62 either during the formation of the armouring element or in a subsequent production pass. Forming of the recess may be done in multiple ways, such as by machining, e.g. rolling, milling, or cutting. A recess surface area fixing part is provided with a desired surface finish 63, i.e. roughness, either during the formation of the recess 62 or in a subsequent step. The desired surface finish 63 may be achieved in various ways, such as by electro-chemical methods, etching, abrasive blasting (sandblasting, glass blasting, etc.), or machining, such as rolling, milling, cutting or honing. The surface area fixing part may be substantially the whole recess surface area, or it may be only a part of the surface area. In the latter case, the surface area fixing part may be provided as a number of surface area fixing sections, together forming the surface area fixing part. An adhesive, e.g. a thermoplastic, is applied 64 in the recess, either in the same pass as the desired surface finish is provided 63, or in a subsequent pass. The adhesive is at least applied to the surface area fixing part, but may be applied to substantially the whole recess surface area. After the adhesive has been applied 64, the sensor element is inserted in the recess 65 and immersed in the adhesive 66 after which the adhesive is allowed to set. In the case of a thermoplastic adhesive, the adhesive may be allowed to set after application but before the sensor element is mounted. In that case, the adhesive must then be heated to liquefy at the time of mounting the sensor element. In this way, an armouring element may be prepared for mounting the sensor element well in advance of the actual mounting. Alternatively, the sensor element may be mounted just after the adhesive has been applied. In some cases, the sensor element may be inserted in the recess 65 before the adhesive is applied to the recess 64. Thus, in this case, the adhesive will by applied on top of the sensor element 65. Alternatively, a thermoplastic adhesive may be applied to the sensor element, e.g. by extrusion, before the sensor element and adhesive is together inserted in the recess.

FIG. 7 is a longitudinal cross-section of the armouring element assembly 50 along the recess 34, during performance of the method steps of application of the adhesive 54 and insertion of the sensor element 52. In one embodiment, the armouring element 30 is fed in the direction of arrow A. The adhesive 54 is applied to the recess 34 with the applicator 72. The sensor element 52 is inserted into the recess 34 and immersed in the adhesive 54 by mechanical action of a force applying tool, here in the form of a glider 74. The glider 74 acts to apply a force to the sensor element 52 in the direction of arrow B to ensure a firm contact between the adhesive 54 and recess 34 surface area fixing part and between the adhesive 54 and sensor element 52. Alternatively, the force applying tool may be a wheel (not shown). In an alternative embodiment, the armouring element 30 is kept immobile, while the applicator 72 and the glider 74 are moved in the opposite direction of arrow A.

The invention is defined by the features of the independent claim(s). Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims. For example, a thermosetting adhesive, such as epoxy, may be used. Additionally, the invention is disclosed using optical fibre sensors, however, in other embodiments, the sensor elements may e.g. be electrical sensors, such as strain gauges, etc.

What is claimed is:

1-48. (canceled)

49. An armouring element for an unbonded flexible pipe, the armouring element having a longitudinal axis and an elongated outer shape along said axis, the armouring element further having a longitudinal recess configured for fully or partly taking up a sensor element, the recess having a recess surface area, at least a surface area fixing part of the recess surface area has a surface finish comprising a surface roughness Ra value of about 0.2 μm or more.

50. The armouring element according to claim 49, wherein the recess is a groove.

51. The armouring element according to claim 49, wherein the surface area fixing part is or comprises substantially the whole recess surface area.

52. The armouring element according to claim 49, wherein the surface area fixing part comprises multiple surface area fixing sections.

53. The armouring element according to claim 52, wherein at least a first surface area fixing section extends over a substantially full recess width and over a section length along the longitudinal direction and wherein the section length is about 10 mm or more

54. The armouring element according to claim 52, wherein the surface area fixing part has a mean section spacing between neighbouring surface area fixing sections, the mean section spacing being about 1 mm or more.

55. The armouring element according to claim 49, wherein the armouring element comprises at least a first surface area fixing part and a second surface area fixing part and the first and second surface area fixing parts have a part spacing of about 1 m or more.

56. The armouring element according to claim 49, wherein the groove is U-shaped.

57. The armouring element according to claim 49, wherein the groove is box-shaped.

58. The armouring element according to claim 49, wherein the element comprises a longitudinally extending outer surface area section wherein the outer surface area section is coarser than the surface area fixing part.

59. The armouring element according to claim 49, wherein the armouring element is made of or comprises a metal.

60. The armouring element according to claim 49, wherein the armouring element is made of or comprises a fibre-reinforced polymer.

61. The armouring element according to claim 49, wherein the armouring element comprises a substantially rectangular cross-section.

62. The armouring element according to claim 61, wherein the recess is substantially centred on a surface area section of the substantially rectangular cross-section.

63. An armouring element assembly comprising an armouring element according to claim 49 and a sensor element, the sensor element being fixed in the recess of the armouring element in contact with an adhesive.

64. The armouring element assembly according to claim 63, wherein the adhesive is or comprises a polyurethane a polyolefin or a thermoplastic

65. The armouring element assembly according to claim 64, wherein the thermoplastic is or comprises at least one of a polyamide, a polyolefin or an acrylic compound.

66. The armouring element assembly according to claim 63, wherein the recess is adapted to fully contain the sensor element.

67. The armouring element assembly according to any one of claims 63, wherein the sensor element comprises an optical fibre sensor, a strain sensor, a temperature sensor, a pressure sensor or an acoustic sensor.

68. An unbonded flexible pipe comprising at least a first armouring element assembly according to claim 63.

69. The unbonded flexible pipe according to claim 68, wherein the pipe comprises a tensile armouring layer, and wherein the tensile armouring layer comprises the first armouring element assembly.

70. The unbonded flexible pipe according to claim 69, wherein the tensile armouring layer additionally comprises at least a first armouring element of a second type, the armouring element of the second type not comprising a sensor element.

71. The unbonded flexible pipe according to claim 70, wherein a mechanical strength, such as a tensile strength, of the first armouring element assembly is substantial equal to the mechanical strength of the first armouring element of the second type.

72. The unbonded flexible pipe according to claim 68, wherein the tensile armouring layer additionally comprises a second armouring element assembly, and optionally a third, a fourth, or a fifth armouring element assembly.
